(19) United States
(12) Patent Application Publication
(10) Pub. No.: US 2009/0144145 A1
(43) Pub. Date: Jun. 4, 2009

(54) MOBILE ADVERTISEMENT METHOD

(75) Inventors: Byung Sik Yoon, Daejeon (KR); Man Ho Park, Daejeon (KR); Song In Choi, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/189,247

(22) Filed: Aug. 11, 2008

(30) Foreign Application Priority Data
Dec. 4, 2007 (KR) 10-2007-0125080

(51) Int. Cl. G06Q 30/00

(52) U.S. Cl. 705/14

(57) ABSTRACT

The present invention relates to a mobile advertising method that performs mobile advertisement using a deep-packet inspection performed in a wireless Internet system and location information. An exemplary embodiment of the present invention includes grasping a purchasing tendency of a subscriber using deep packet inspection of an electronic surveillance system; and providing advertisement for desired goods to the subscriber by connecting the grasped purchasing tendency of the subscriber with a location-based service (LBS). Accordingly, the present invention can contribute to an increase in sales profits of the service provider to reduce the resistance and burden for the installation of the electronic surveillance system, and maximize the advertising effect of the advertiser. Further, the subscriber can receive required information on the basis of the current location.

### CROSS-REFERENCE TO RELATED APPLICATION

This application claims priority to and the benefit of Korean Patent Application No. 10-2007-0125080 filed in the Korean Intellectual Property Office on Dec. 4, 2007, the entire contents of which are incorporated herein by reference.

### BACKGROUND OF THE INVENTION

(a) Field of the Invention

The present invention relates to a mobile advertisement method. More particularly, the present invention relates to a mobile advertising method that performs mobile advertisement using a deep-packet inspection performed in a wireless Internet system, and location information.

The present invention was supported by IT R&D program of MIC/IITA [2006-S-009-02, The Development of WiBro Service and Operating Standard].

(b) Description of the Related Art

In recent years, the use of the Internet using a wireless communication system such as WiBro or high speed downlink packet access (HSDPA) has rapidly increased, and the use thereof is forecasted to be more rapidly increased in the future. Further, technologies that precisely measure location information of a terminal that uses wireless internet are being continuously developed, for example a global positioning system (GPS) or a network based positioning system, such that the usage of the Internet and the location information are being merged with each other.

The mobile Internet communication is one of the most remarkable technologies in recent years, and will be very significantly developed in the future. In particular, according to recent research, it is known that 34% of internet users use wireless internet at home, offices, or other locations. Further, the ARC group estimates that the number of wireless Internet users will be close to the number of mobile phone service users by 2006.

The fields of wireless Internet service are mainly classified into a communication service such as electronic mail or fax, a text information service, and mobile commerce. Particularly, the mobile commerce will lead the wireless internet service in the future and thus the central axis of electronic commerce is expected to be moved to mobile commerce. Further, the worldwide mobile commerce market will rapidly expand by influence of the third generation IMT-2000 service.

Thus far, the mobile commerce market is limited to information related fields, but it will expand to various fields such as advertising, finance, business applications, transportation systems, and shopping.

The domestic wireless Internet markets are in a new take-off stage from 2006. This is because the era of the wideband wireless Internet called mobile broadband is beginning. Particularly, HSDPA and WiBro technologies are rapidly increasing their market share with the aim of providing various terminal and Internet environments at a high transmission speed and a low cost, and are becoming foundation stones for preoccupying the global market. Further, location-based services (LBS) that provide various services by using position and location information are being merged with the wireless Internet.

The merging of the wireless Internet technology and location-based services brings forth particular technology that is capable of creating a new significant application in the era of wideband wireless Internet such as HSDPA or WiBro.

However, with the rapid progress of the communication systems, at a point of time when various networks and communication systems are merging with each other, the number of various criminals and terrorists that use the communication systems is increasing.

Therefore, by way of provisions against crime and terrorism, systematic and efficient communication electronic surveillance system is demanded, and legally-allowed communication electronic surveillance systems are being used in the United States and most countries in Europe. Particularly, research concerning data interception is rapidly and repeatedly improved, and more recently, a deep packet inspection method that inspects entire internet data packets on all layers is being highlighted. That is, the deep packet inspection is a technology that extracts required data by searching data even on an application layer (that is, the uppermost layer data), and then collects various information concerning the layer.

FIG. 1 is a diagram showing a system that electronically supervises a specific subscriber in an ordinary WiBro system.

Generally, as shown in FIG. 1, the system that electronically supervises a specific subscriber in an ordinary WiBro system includes a WiBro service provider 110, a lawful enforcement agency (LEA) 120, and a target subscriber 130.

The WiBro service provider 110 receives an electronic surveillance permission for a specific subscriber from the LEA 120 to register the electronic supervisor of the specific subscriber. When the target subscriber 130 demands a connection, the provider transmits the information concerning the subscriber (intercept related information (IRI)) to the LEA 120. Further, if the interception for the actual communication specification of the target subscriber 130 is required, the provider responds to the demand of the target subscriber 130 while sending a request for the interception. Further, the provider collects information data relating to the connection of the target subscriber 130 and transmits the data to the LEA 120. Furthermore, the provider copies the call contents (CC) between the target subscriber 130 and the other side when they communicate with each other to transmit to the LEA 120.

The WiBro service provider 110 includes a WiBro lawful interception (LI) manager 111, a delivery device 112, an authentication server 113, and a WiBro network 114.

The WiBro LI manager 111 receives permission (Admin(HI1)) from the LEA 120 to request the electronic surveillance registration Admin of a specific subscriber.

The delivery device 112 registers the electronic surveillance (Config) of the specific subscriber on the authentication server according to the request for the electronic surveillance registration Admin of the specific subscriber approved by the WiBro LI manager 111. The delivery device 112 extracts proper information IRI from the subscriber-related information IRI received from the authentication server 113 and then transmits it to the LEA 120. If the delivery device 112 desires to intercept the actual communication specification for the target subscriber 1301 the delivery device 112 requests the interception to a WiBro access control router (ACR) in the WiBro network 114, and notifies the authentication server 113 to acknowledge (Ack) the demand to intercept the communication of the target subscriber 130. The delivery device 112 transmits the IRI-concerning charging information, connection information of the other party, and so on transmitted from the authentication server to the LEA 120. The delivery device 112 transmits the actual communication data copied through the WiBro network 114 to a collection device 121 of the LEA 120.

After registering the electronic surveillance (Config) of the specific subscriber delivered through the delivery device 112 on an AAA server, when the target subscriber 130 demands the connection, the authentication server 113 transmits subscriber related information IRI such as phone number information, IP information, or connection information of the subscriber to the delivery device 112. According to the response notification from the delivery device 112, the authentication server 113 permits the connection of the target subscriber 130 and collects data such as charge information in relation to the specific connection, connection information of the other party, and IP information of a third party through the WiBro network 114 to transmit it to the delivery device 112.

The WiBro network 114 includes a WiBro radio access station (RAS) and a WiBro ACR, and performs communication between the WiBro service provider 110 and the target subscriber 130. The WiBro network 114 collects data such as charge information in relation to the connection of the target subscriber 130, connection information of the other party, and IP information of the third party to transmit the data to the authentication server 113. When the target subscriber 130 actually performs the connection with another party, the WiBro network 114 copies the actual communication data to transmit the data to the delivery device 112.

The LEA 120 is a machinery of law that performs the electronic surveillance, and receives permission of the electronic surveillance of a specific subscriber from a court, and transmits the contents of permission (Admin(HI1)) to the WiBro service provider 110.

The LEA 120 includes the collection device 121 to collect information concerning the subscriber when the target subscriber 130 demands the connection, information data relating to the connection of the target subscriber 130, and communication data when the target subscriber 130 communicates with another party from the WiBro service provider 110.

The target subscriber 130 transmits the connection demand to the WiBro service provider 110 using a WiBro terminal in order to commit a crime, and then connects with the WiBro service provider 110.

Referring to FIG. 1, the scenario of an electronic surveillance operation in an ordinary WiBro system will be described.

The LEA 120 that is the machinery of law LEA performing the electronic surveillance receives permission for the electronic surveillance with respect to the specific subscriber from a court, and then notifies the contents of the permission (Adimin(HI1)) to the WiBro LI manager 111 located in the WiBro service provider 110.

Accordingly, the WiBro LI manager 111 receives the contents of permission (Admin(HI1) notified from the LEA 120 and requests the registration (Admin) of the electronic surveillance of the specific subscriber to the delivery device 112 located in the WiBro service provider 110.

According to the registration of the electronic surveillance of the specific subscriber that is permitted by the WiBro LI manager 111, the delivery device 112 immediately registers the electronic surveillance (Config) of the specific subscriber on the authentication server 113 located in the WiBro service provider 110.

In this case, the target subscriber 130 transmits the access request to the authentication server 113 in order to commit the crime through the WiBro network 114 located in the WiBro service provider 110, and then connects to the authentication server 113.

Thereby, the authentication server 113 transmits subscriber-related information IRI such as phone number information, IP information, or connection information of the target subscriber 130 to the delivery device 112 as soon as the target subscriber 130 connects to the authentication server 112.

Then, the delivery device 112 extracts proper information IRI from the subscriber-related information IRI transmitted from the authentication server 113 and then sends the extracted information to the collection device 121 located in the LEA 120.

Thereafter, if there is a request for interception of the actual communication specification with respect to the target subscriber 120, the delivery device 112 performs the interception request using the WiBro ACR provided in the WiBro network 114 and notifies the authentication server 112 to respond (Ack) to the request of the target subscriber 130.

Therefore, the authentication server 113 receives the notification from the delivery device 112 to give the access permission to the target subscriber 130, and collects data IRI such as charge information with respect to a specific connection, connection information of the other party, and IP information of the other party through the WiBro ACR provided in the WiBro network 114.

Further, the authentication server 113 transmits the data IRI concerning the charge information and the connection information of the other party to the collection device 121 of the LEA 120 through the delivery device 112.

Thereafter, when the target subscriber 130 actually communicates with the other party, the authentication server copies the actual communication data (call contents: CC) in the WiBro ACR provided in the WiBro network 114 to transmit the intercepted data to the delivery device 112.

In this case, the delivery device 112 transmits the information CC collected by the WiBro ACR to the collection device 121 of the LEA 120.

Here, the above-described electronic surveillance is performed by providing an IP probe in a specific line in the network according to the related art. For example, a device for a deep packet inspection is provided in a line connected with the authentication server 112 of the AAA shown in FIG. 1 or a line connected with the WiBro ACR. With this configuration, when a specific IP, a specific ID, or a specific phrase is searched and a specific searching word is found, the related packet is copied and analyzed in the delivery device 112 to be transmitted to the LEA 120.

In the meantime, the above-mentioned deep packet inspection method inspects all data packets with a high transmission rate from protocol layer 2 to layer 7 at high speed to find a specific phrase.

Further, the deep packet inspection is mainly used for a passive solution method among electronic surveillance methods. The characteristic of the passive electronic surveillance method is that an IP probe is provided in an existing network to perform the interception of the related data. The passive electronic surveillance method can provide the electronic surveillance function without changing the configuration of the existing network.

Next, referring to FIG. 2, a passive electronic surveillance method of the ordinary WiBro system will be described.

FIG. 2 is a diagram illustrating the passive electronic surveillance operation method in an ordinary WiBro system.

At first, an electronic surveillance manager 210 determines (that is, targets) an electronic surveillance target through a delivery device 220. In this case, settings (that is, internet targeting) of a tapping device 241 that detects IRI data and a tapping device 242 that detects CC data are completed in an IP probe 230.

Thereafter, the IP probe 230 detects target-related IRI and CC data and then transmits call data to the delivery device 220, and finally transmits call contents to the machinery of law.

However, most communication companies in the United States and Europe have to compulsorily install legal electronic surveillance equipment in their communication systems for public safety. These technologies that do not make any profit are a financial burden on the companies, but the companies do not have choice because the installation is compulsory by law.

Therefore, it is seriously required to maximize advertisement profits and 5 earnings obtained by the electronic commerce by efficiently using the electronic surveillance equipment and the LBS equipment and exactly grasping the purchasing tendency of their subscribers and their location information.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a mobile advertising method that uses a deep packet inspection performed in a wireless internet system, and location information.

Further, another object of the present invention is to efficiently use a specific search result performed in a wireless Internet system for the mobile advertisement by merging the electronic surveillance system and location information.

Therefore, according to the present invention, by using the deep packet inspection generally used for the Internet electronic surveillance, the purchasing tendency of a specific subscriber is grasped and the result (that is, the purchasing tendency) is connected to the LBS to promptly and exactly send personalized advertisements for desired purchasing goods to the specific subscriber, which activates electronic commerce.

An exemplary embodiment of the present invention provides a mobile advertising method in a wireless Internet system that includes grasping a purchasing tendency of a subscriber using deep packet inspection of an electronic surveillance system, and providing advertisements for desired goods to the subscriber by connecting the grasped purchasing tendency of the subscriber with a location-based service (LBS).

The mobile advertising method may further include discounting a part of a call charge of the subscriber when the deep packet inspection is accepted.

In this case, the grasping of the purchasing tendency may include: receiving an advertisement request from an advertiser to set advertising goods into an IP probe using the electronic surveillance system; when the subscriber searches information about the advertising goods, detecting the advertising goods by performing a deep packet data search using the IP probe; collecting information about the subscriber who searches the advertising goods; and registering the purchasing tendency of the subscriber by analyzing and processing the collected subscriber information. Furthermore, the setting of advertising goods into the IP probe may include allowing a delivery device of the electronic surveillance system to request the IP probe to search the advertising goods, and allowing the IP probe to target the advertising goods using a tapping device.

Furthermore, the providing of the advertisement for the purchasing goods may include: registering information about a store to be advertised according to the request for registering the location of the store of the advertiser; requesting the location of a subscriber who searches the advertising goods to the LBS server; and receiving the location of a subscriber who searches the advertising goods from the LBS server to provide advertisement that is suitable for the location of the subscriber to the subscriber.

Here, the requesting of the location of the subscriber to the LBS server may periodically request the information about the location of a subscriber who searches the advertising goods in the LBS server.

The providing of the advertisement to the subscriber may provide the advertisement for the advertising goods to the subscriber when the location of the subscriber is close to the location of the store. Further, the providing of the advertisement to the subscriber may provide information about a store of the advertiser that is closest to the location of the subscriber to the subscriber when the subscriber does not approach the store of the advertiser even after the passage of a predetermined time.

According to the above-described exemplary embodiment of the present invention, from the viewpoint of the service provider, the existing electronic surveillance equipment can be used for the advertisement, which contributes to increases in sales profits, thereby reducing the resistance and burden of the service provider for the installation of the electronic surveillance system. Further, from the viewpoint of the advertiser, it is possible to grasp the purchasing tendency of the specific subscriber to provide the on-demand information or advertisement only for a specific subscriber, which maximizes the advertisement effect. Furthermore, from the viewpoint of the subscriber, the subscriber can receive various required information on the basis of the current location of the subscriber to enjoy a distinctive service such as context-based service (CBS) that is an aim of ubiquitous computing.

### BRIEF DESCRIPTION OF THE DRAWINGS

FIG. 1 is a diagram showing a system that electronically supervises a specific subscriber in an ordinary WiBro system.

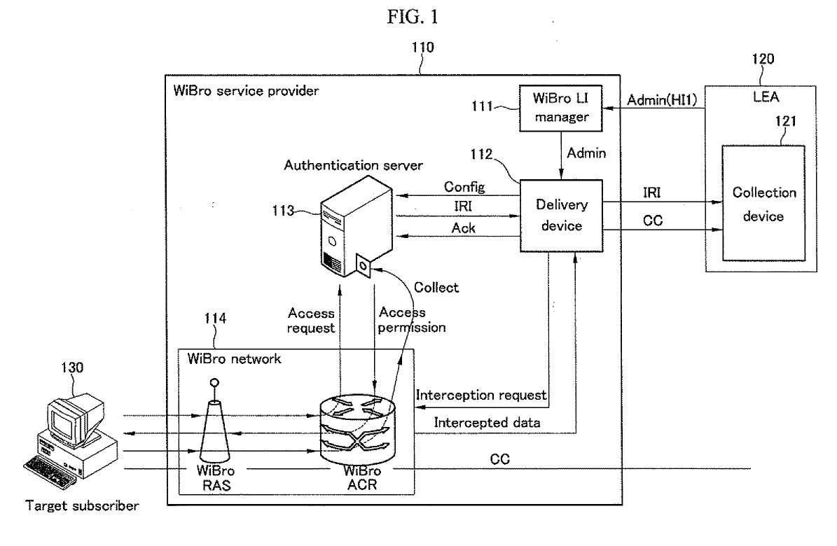

FIG. 2 is a diagram illustrating the passive electronic surveillance operation method in the ordinary WiBro system.

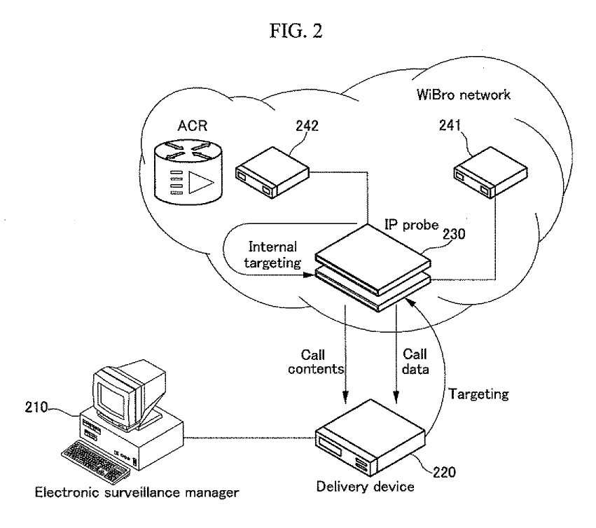

FIG. 3 is a diagram illustrating a mobile advertising method according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing is from the spirit or scope of the present invention. Accordingly, the drawings and description are to be regarded as illustrative in nature and not restrictive. Like reference numerals designate like elements throughout the specification.

It will be understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. The term “unit”, “-er”, or “module” used herein means a unit that processes a specific function or operation, and may be implemented by hardware or software, or a combination thereof.

Hereinafter, a mobile advertising method according to an exemplary embodiment of the present invention will be described in detail with reference to an accompanying drawing.

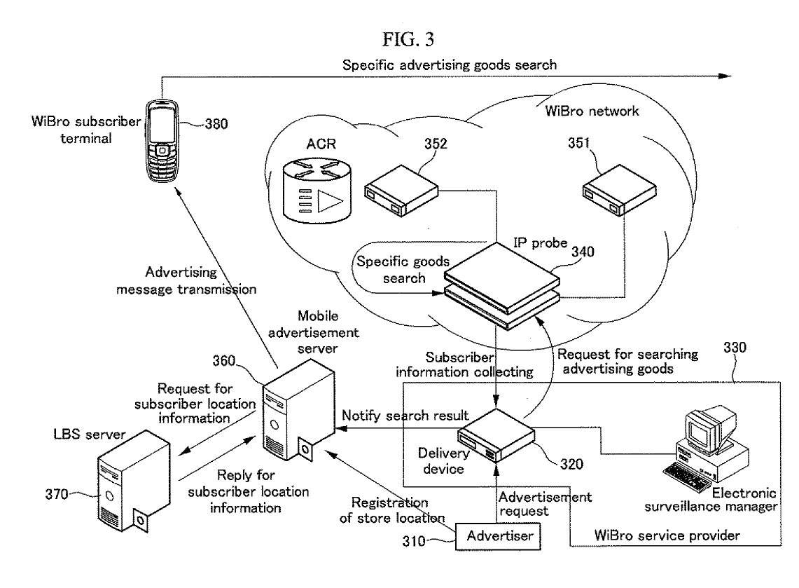

FIG. 3 is a diagram illustrating a mobile advertising method that uses deep packet inspection and location information according to an exemplary embodiment of the present invention.

As shown in FIG. 3, a mobile advertising system that uses the deep packet inspection and the location information according to the exemplary embodiment of the present invention includes an advertiser 310, a delivery device 320, an electronic surveillance manager 330, an IP probe 340, a first tapping device 351, a second tapping device 352, a mobile advertisement server 360, an LSB server 370, and a WiBro subscriber terminal 380.

The advertiser 310 refers to a communication terminal for the advertiser, and it requests the advertisement of the advertiser 310 to the delivery device 320 and requests the mobile advertisement server 360 to register the location of a store of the advertiser 310.

The delivery device 320 requests the IP probe 340 to set specific advertising goods of a company that wants the advertisement according to the control of the electronic surveillance manager 330, and receives collected subscriber information from the IP probe 340 to analyze and process the information and notify the search result with respect to the specific advertising goods to the mobile advertisement server 360.

The electronic surveillance manager 330 transfers the searching request for specific advertising goods to the IP probe 340 through the delivery device 320 according to the advertisement request transmitted from the advertiser 310.

The IP probe 340 targets an electronic surveillance object (that is, specific advertising goods) according to the searching request delivered by the delivery device 320, and collects the subscriber information corresponding to data detected by the tapping devices 351 and 352 to transfer the information to the delivery device 320.

The first tapping device 351 detects IRI data according to the control of the IP probe 340 to transmit the data to the IP probe 340, and the second tapping device 352 detects CC data according to the control of the IP probe 340 to transmit the data to the IP probe 340.

The mobile advertisement server 360 registers information about the store location of the advertiser 310 in a database according to the store location registration request transferred from the advertiser 310, receives the searching result with respect to specific advertising goods from the delivery device 320, and requests the location of a subscriber that searches the specific advertising goods to the LBS server 370. Thereafter, the mobile advertisement server 360 receives the subscriber location information from the LBS server 370 to transmit store information, price information of specific goods, and event information suitable for the location of the subscriber to the WiBro subscriber terminal 380.

The LSB server 370 receives the request for the subscriber location from the mobile advertisement server 360 and confirms the location of the subscriber that searches the specific advertising goods to reply to the mobile advertisement server 360.

The WiBro subscriber terminal 380 searches information (for example, user's postscript, price comparison, etc.) about specific advertising goods through a WiBro network using the Internet, and provides store information, price information of specific goods, and event information suitable for the subscriber location transferred from the mobile advertisement server 360 to the subscriber.

Hereinafter, a mobile advertising method according to an exemplary embodiment of the present invention will be described in detail referring to FIG. 3.

First, an advertiser 310 requests the advertisement of an advertiser's company to a WiBro service provider using a communication terminal for the advertiser. At this time, the advertiser 310 registers store location of the advertiser in a mobile advertisement server 360 installed by the WiBro service provider. Therefore, the mobile advertisement server 360 registers the information about the store location transferred from the advertiser 310.

A delivery device 320 provided in the WiBro service provider receives the request for the advertisement of the advertiser's company from the advertiser 310, and sets desired advertising goods of the company that desires the advertisement into the IP probe 340 using an electronic surveillance system (that is, a system of the WiBro service provider). That is, the electronic surveillance manager 330 transfers the request for searching the specific advertising goods to an IP probe 340 through the delivery device 320, which allows the IP probe 340 to target an electronic surveillance object (that is, specific advertising goods).

Thereafter, when the subscriber searches information (for example, the user's postscript or price comparison) about specific advertising goods through the WiBro subscriber terminal 380 of the subscriber via the Internet, tapping devices 351 and 352 performs deep packet data inspection according to the control of the IP probe 340 to detect the specific advertising goods to transmit to the IP probe 340.

Accordingly, the IP probe 340 collects subscriber information (for example, a subscriber IP) corresponding to the detected specific advertising goods detected by the tapping devices 351 and 352. At this time, the service provider can offer an incentive policy that discounts a part of a call charge in order to accept the deep packet inspection.

That is, the IP probe 340 collects information about a subscriber that searches the specific advertising goods to transmit the collected subscriber information to the delivery device 320 of the electronic surveillance system.

Accordingly, the delivery device 320 analyzes and processes the subscriber information transferred from the IP probe 340, and then transmits the information to the mobile advertisement server 360 as a result of searching the specific advertising goods.

Then, the mobile advertisement server 360 receives the searched result for the specific advertising goods from the delivery device 320 to request the location of the subscriber that searches the specific advertising goods to the LBS server 370. Otherwise, the mobile advertisement server 360 periodically requests the information about the location of the subscriber that searches the specific advertising goods to the LBS server 370.

Accordingly, the LBS server 370 confirms the location of the subscriber according to the request for the subscriber's location transferred from the mobile advertisement server 360, and notifies the confirmed information about the subscriber's location to the mobile advertisement server 360.

Therefore, the mobile advertisement server 360 receives the location information of the subscriber that searches the specific advertising goods from the LBS server 370 to transmit store information suitable for the location of the subscriber, price information of specific goods, and event information as an advertisement message to the WiBro subscriber terminal 380.

Then, the WiBro subscriber terminal 380 receives the advertisement message from the mobile advertisement server 360 to provide the message to the user through a screen.

In the above-described mobile advertising method according to the exemplary embodiment of the present invention, the operation is described on the assumption that all searches using the WiBro wireless wideband Internet are legally performed. However, the present invention is not limited thereto.

Further, in the present invention, the IP probe 340 for the electronic surveillance in the wireless Internet system is not limited to the target subscriber, but is used to determine the preference of a specific subscribe for specific goods by detecting specific goods or search words for every subscriber.

In other words, in the present invention, when the deep packet inspection is performed on specific goods using the IP probe 340, it is possible to easily find a specific subscriber that searches the price or information of the goods via the Internet. Undoubtedly, the inspection is performed after removing illegal factors with the prior consent of the subscriber.

Further, the goods information and the advertisement is changed to a form that is suitable for the mobile subscriber using the information obtained as described above, and is then directly transmitted to the mobile subscriber by considering the location thereof. That is, if the location of the mobile subscriber is close to the store to be advertised, the service provider who previously understands that the mobile subscriber is interested in the specific goods directly sends the advertisement for the specific goods to the subscriber to increase the purchasing power for the goods.

According to the above-described exemplary embodiment of the present invention, a mobile advertisement method that grasps the purchasing tendency of a specific subscriber using a deep packet data searching method in the wireless Internet system to use for advertisement has been described.

Here, the exemplary embodiment of the present invention grasps the purchasing tendency of the specific subscriber using an electronic surveillance system to use it for advertisement. Further, the exemplary embodiment of the present invention grasps the purchasing tendency and the location of the specific subscriber and builds a mobile advertisement server on the basis of the information to use the information for advertisement. The embodiment may be mainly applied to mobile commerce that will be used as a significant application in the wireless internet market in the future by merging the wireless Internet and the location information.

Further, according to an exemplary embodiment of the present invention, the purchasing tendency of the subscriber is stored, and then when the subscriber is located close to the store of the advertiser, the advertisement message is transmitted to the subscriber's mobile device. Furthermore, according to the exemplary embodiment of the present invention, when the subscriber does not approach the store of the advertiser even after the passage of a predetermined time, information about a store of the advertiser that is closest to the location of the subscriber is transmitted.

Otherwise, according to the exemplary embodiment of the present invention, the data search or electronic inspection method and the location information are merged with each other in the wireless internet system to be used for the advertisement. In this case, the exemplary embodiment of the present invention may provide a service that discounts the call charge when the deep packet electronic inspection is accepted.

According to the above-described exemplary embodiment of the present invention, from the viewpoint of the service provider, the existing electronic surveillance equipment can be used for the advertisement, which contributes to increases in sales profits, thereby reducing the resistance and burden of the service provider for the installation of the electronic surveillance system.

Further, from the viewpoint of the advertiser, it is possible to grasp the purchasing tendency of the specific subscriber to provide the on-demand information or advertisement only for a specific subscriber, which maximizes the advertisement effect. In addition, from the viewpoint of the subscriber, the subscriber can receive the required various information on the basis of the current location of the subscriber to enjoy a distinctive service such as CBS that is an aim of ubiquitous computing.

The exemplary embodiment of the present invention that has been described above may be implemented by not only an apparatus and a method but also by a program that is capable of realizing a function corresponding to the structure according to the exemplary embodiment of the present invention and a recording medium having the program recorded therein. It can be understood by those skilled in the art that the implementation can be easily made from the above-described exemplary embodiment of the present invention.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A mobile advertising method in a wireless Internet system, comprising:
grasping a purchasing tendency of a subscriber using deep packet inspection of an electronic surveillance system; and
providing advertisement for desired goods to the subscriber by connecting the grasped purchasing tendency of the subscriber with a location-based service (LBS).

2. The method of claim 1, further comprising
discounting a part of a call charge of the subscriber when the deep packet inspection is accepted.

3. The method of claim 1, wherein the grasping of the purchasing tendency includes:
receiving an advertisement request from an advertiser to set advertising goods into an IP probe using the electronic surveillance system;
when the subscriber searches information about the advertising goods, detecting the advertising goods by performing deep packet data search using the IP probe;
collecting information about the subscriber who searches the advertising goods; and
grasping the purchasing tendency of the subscriber by analyzing and processing the collected subscriber information and registering the purchasing tendency.

4. The method of claim 3, wherein the setting of advertising goods into the IP probe includes:
allowing a delivery device of the electronic surveillance system to request the IP probe to search the advertising goods; and
allowing the IP probe to target the advertising goods using a tapping device.

5. The method of claim 3, wherein the providing of the advertisement for the purchasing goods includes:
registering information about a store to be advertised according to the request for registering the location of the store of the advertiser;
requesting the location of a subscriber who searches the advertising goods to the LBS server; and
receiving the location of a subscriber who searches the advertising goods from the LBS server to provide advertisement suitable for the location of the subscriber to the subscriber.

6. The method of claim 5, wherein the requesting of the location of the subscriber to the LBS server periodically requests the information about the location of a subscriber who searches the advertising goods to the LBS server.

7. The method of claim 5, wherein the providing of the advertisement to the subscriber provides the advertisement for the advertising goods to the subscriber when the location of the subscriber is close to the location of the store.

8. The method of claim 5, wherein the providing of the advertisement to the subscriber provides information about a store of the advertiser where is the closest to the location of the subscriber to the subscriber when the subscriber does not approach the store of the advertiser even after the passage of a predetermined time.
